(19) United States
(12) Patent Application Publication
(10) Pub. No.: US 2010/0030596 A1
(43) Pub. Date: Feb. 4, 2010

(54) Business Process Intelligence

(76) Inventor: Gaurav Johari, Irving, TX (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/182,781

(22) Filed: Jul. 30, 2008

(51) Int. Cl. G06F 19/00

(52) U.S. Cl. 705/7

(57) ABSTRACT

Systems, methods, and apparatus, including software tangibly stored on a computer readable medium, involve managing business information in an enterprise. Multiple business operations are identified for achieving a business objective in the enterprise, and one or more data operations are identified for managing information related to a subset of the business operations. An automated business process is defined for implementing the business operations and the data operation. The automated business process initiates the data operation based on execution of the subset of business operations. The automated business process is stored for repeated use in the enterprise.

### BACKGROUND

This description relates to managing business information in an enterprise.

An enterprise, such as a business, an organization, or an individual, may implement one or more business processes for achieving objectives and/or accomplishing tasks of the enterprise. A business process can include one or more business operations that are carried out automatically, for example, by a computing device or an information processor. A business process may also include one or more business operations that involve manual activities, such as user input or physical manipulation. For example, an enterprise may implement business processes for collecting customer feedback, ordering assets and/or services, collecting job applications, scheduling meetings, training employees, selling goods and services, up-selling goods and services, applying for leave, allocating resources, tracking assets, and/or any other enterprise task. In some cases, after a business process has been executed in an enterprise one or more times and/or by one or more users, a business intelligence system may analyze the previous executions of the business process. In such a case, the business intelligence system analyzes historical information.

### SUMMARY

In one general aspect, multiple business operations are defined for achieving a business objective in an enterprise, and one or more data operations are identified for managing information related to a subset of the business operations. An automated business process is defined for implementing the business operations and the data operation. The automated business process initiates the data operation based on execution of the subset of business operations. The automated business process is stored for repeated use in the enterprise.

Implementations can include one or more of the following features. The business objective includes ordering a business asset, ordering a business service, managing employees of the enterprise, managing assets of the enterprise, communicating with customers of the enterprise, and/or marketing a good or a service of the enterprise. The data operation defines an operation for managing information related to analysis of efficiency and/or effectiveness of the subset of business operations. The data operation defines an operation for automatically storing data related to the subset of business operations. Execution of the subset of business operations instantiates one or more data values for one or more data fields related to the subset of business operations. The identification of a data operation defines a relative importance of at least one data field relative to the other data fields. The data operation defines an operation for comparing the instantiated data value to a threshold data value, an equation for analysis of the data values, a relationship among at least two of the data fields, an operation for comparing the data values to a data condition, and/or an operation for automatically providing data to a business intelligence system and/or a business warehouse system upon implementation of the subset of business operations. The automated business process initiates the data operation concurrently with implementation of at least a portion of the subset of business operations. The subset of business operations can include no more than one business operation, or the subset of business operations can include more than one business operation. Multiple additional data operations are identified for managing information related to multiple additional subsets of the business operations. The automated business process initiates each additional data operation based on execution of a corresponding subset of the business operations. A graphical user interface allows a user to provide identification of the subset of business operations and/or the data operation. The graphical user interface allows a user to provide identification of a report to generate upon execution of the subset of business operations. The multiple business operations are defined by receiving data from a user through a user interface, and the data operation is identified by the user through a user interface. The data operation is identified approximately concurrently with defining the multiple business operations. The subset of business operations are executed using a business process execution engine, and the data operation is initiated using the business process execution engine. The data operation is initiated based on the execution of the subset of business operations. A data extractor is generated using the business process execution engine. The data extractor is generated based on the initiation of the data operation. The automated business process is defined in an electronic document. The electronic document includes extensible markup language (XML) code. The described techniques can be implemented in methods, systems, apparatus, computer program products, or otherwise, tangibly stored on a computer readable medium as instructions operable to cause programmable processor to perform actions.

The details of one or more implementations are set forth in the accompanying drawings and the description below. Other features will be apparent from the description and drawings, and from the claims.

### DESCRIPTION OF DRAWINGS

FIG. 1 is a block diagram illustrating an example system for managing business information.

FIG. 2 is a signaling diagram illustrating an example process for managing business information.

FIG. 3 is a flow diagram illustrating an example process for managing business information.

FIG. 4 is a block diagram illustrating an example data processing system.

Like reference symbols in the various drawings indicate like elements.

### DETAILED DESCRIPTION

A business process design tool allows a business user to design a business process that includes business operations and data operations. For example, a business user can design a business process that includes business operations to achieve a business objective, and while designing the business process, the user can specify data operations to be executed when the business process is implemented. When designing the business process (e.g., by identifying or defining the business operations), the user can identify data operations to be performed in connection with execution of the business process. The data operations can be identified substantially concurrently with designing the business process, such that the person or persons designing the business process can specify what data operations are to be performed at approximately the same time as specifying the business operations to be performed. In some implementations, the identified data operations can include selecting fields of interest for populating a business warehouse and/or data specifying analysis to be performed through execution of a business intelligence process. In some implementations, a user can apply business-domain knowledge to specify, for example, what data should be extracted when the business process is implemented, a relationship among data fields, a relative importance of various data fields, thresholds to monitor, reports and/or alerts to issue, formulae to apply, and other information. When the business process is executed, the data operations can perform analysis and/or extract information of interest during the runtime of the business process. Thus, in some cases, a business intelligence system can retrieve or even analyze data during a runtime of the business process. If the business operations in the business process are modified, analysis of the modified business process can be incorporated directly into the modified business process, for example, by modifying, adding, and/or deleting data operations substantially concurrently with modifying the business operations.

As an example, an enterprise may define a business process for managing a customer relationship after the customer makes a purchase. The business process may include multiple business operations for communicating with the customer and/or determining what type of messages to send the customer. For example, a first business operation may include instructions to send an e-mail to the customer two days after the customer purchases a television from the enterprise. The email includes a customer-satisfaction survey for collecting feedback on the transaction. A second business operation may include instructions to send a second e-mail to the customer if, in response to the first e-mail, the customer provided positive feedback. The second e-mail may include a promotional offer for a special price on a gaming system. The example business process also includes a data operation to automatically extract business data upon execution of the first and/or second business operations. The data operation includes instructions to store identification of the customers who purchased the gaming system after receiving the second email. The identification may be stored and/or transmitted to a business warehouse system. A business intelligence may use the data to identify trends or other statistical data related to the effectiveness of the promotional offer or the business process itself.

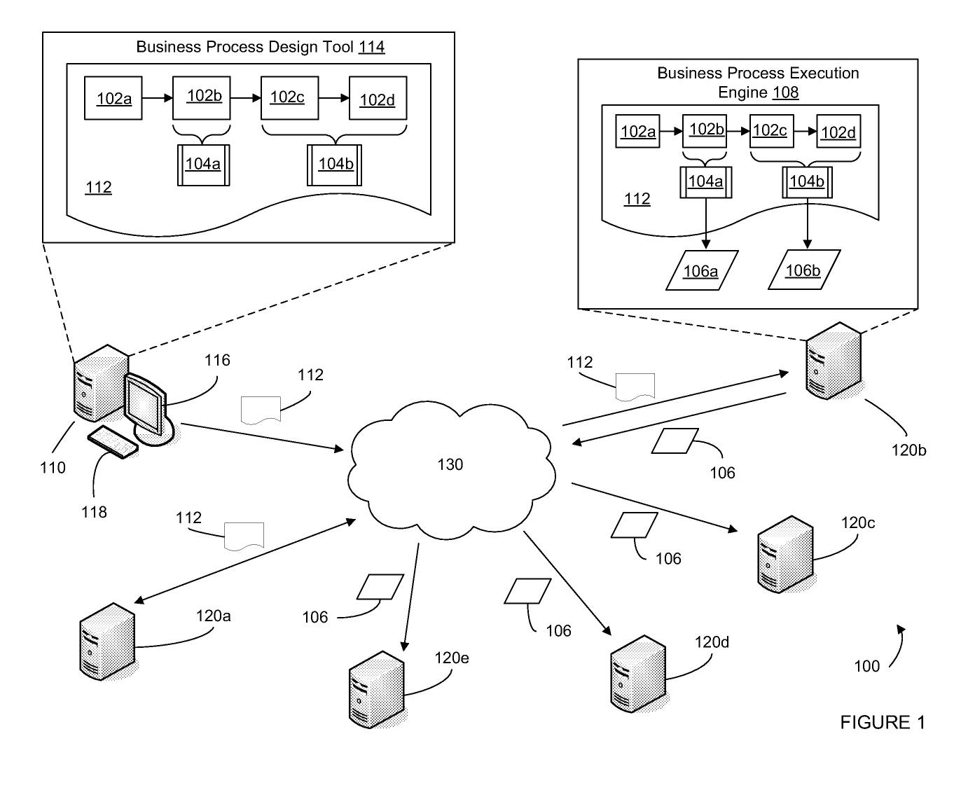

FIG. 1 is a block diagram illustrating an example system 100 for managing business information. The system 100 includes multiple data processing systems 110, 120a, 120b, 120c, 120d, and 120e adapted to communicate over a network 130. For example, the data processing systems can send and receive electronic files and other data related to business processes of an enterprise. The network may be any type of public or private network, including a local area network (LAN), a wide area network (WAN), the Internet, and/or others.

The data processing system 110 implements an example business process design tool 114. The business process design tool 114 may be implemented as a software application or a software application module. For example, all or a portion of the business process design tool may be implemented using ARIS Modeler software, from IDS Scheer AG of Germany. The business process design tool 114 can present graphical data, for example to a user, through a monitor 116. The business process design tool 114 may also present data through additional interface devices. The business process design tool 114 may send and/or receive data, for example from a user, through the keyboard 118, a mouse, a microphone, and/or another type of interface device.

The business process design tool 114 allows a user to design a business process 112 that includes both business operations 102 for achieving a business objective and data operations 104 for managing information related to the business process. The business operations 102a, 102b, 102c, and 102d can be used to achieve the business objective and/or complete a relevant business task independent of the data operations 104a and 104b. By allowing a business process designer to include data operations 104 in the business process 112, the business process design tool 114 allows a business user to directly specify and/or prioritize in the business process 112 what information is most relevant for analysis of the business process 112. For example, a business user may select data operations 104 based on business-domain knowledge, such as planned or predicted analysis of the business process 112 and/or the business operations 102. In some implementations, the business-user can define criteria for analyses of the business process directly with the business process.

The business operations 102 can include various actions. For example, business operations 102 may define instructions for requesting data, communicating data, transferring data, defining data, sending messages, receiving messages, and/or other business activities. The business operations 102 can include all types of business activities, business rules and/or business logic. For example, the business operations 102 can evaluate parameters, instantiate variables and/or data fields, apply formulae and/or implement logic to make business decisions. In some cases, a business process 112 includes business operations 102 that evaluate conditional statements. Thus, the particular business operations 102 that are executed and/or the order in which the example business operations 102 are executed may vary among implementations or executions of the business process 112.

The data operations 104 can each be associated with one or more of the business operations 102. The business process 112 can be adapted to automatically initiate a data operation 104 based on the implementation of one or more associated business operations 102. For example, the data operation 104a is associated with the business operation 102b, and the data operation 104b is associated with the business operations 102c and 102d. The business process 112 is adapted to initiate the data operation 104a upon execution of the business operation 102b. The business process 112 is adapted to initiate the data operation 104b upon execution of the business operation 102c and/or the business operation 102d. In some cases, a business process 112 is adapted to initiate a data operation 104 concurrently with an associated business operation 102. In some cases, a business process 112 is adapted to initiate a data operation 104 before, during and/or after execution of one or more associated business operations 102.

The data operations 104 can be adapted such that, for example, during runtime of the business process 112 a data operation 104 identifies relationships among data fields, identifies a priority or importance of a data field, generates an information extractor to extract information of interest, provides a report, performs analysis, formats data, stores specific data, monitors thresholds and alerting conditions, calculates values based on formulae, and/or performs other information management tasks. Since the data operations 104 are integrated into the business process 112, the data operations 104 can reduce or eliminate a need to separately identify data fields of interest after a business process 112 has been defined. Integration of the data operations 104 into the business process 112 can reduce or eliminate a need to extract information of interest apart from and/or after implementing the business process 112. The data operations 104 can reduce or eliminate a need to search, sort, and/or filter data generated during business process 112 implementation. For example, execution of the data operations 104 may automatically extract and/or prioritize the most relevant data to be used by a business intelligence system. In some cases, this reduces or eliminates a need to collect information of interest by other techniques, such as extracting data in an offline mode, extracting historical data from a database, searching and/or filtering e-mails, spreadsheets, web pages, word processing files, and other types of documents. Execution of the data operations 104 may reduce an amount of time required for incorporating changes to analyses criteria into business processes.

In the illustrated example, an enterprise defines a business process 112 for ordering a service, such as a telephone line, for use by the enterprise. The business process 112 includes multiple business operations 102a, 102b, 102c, and 102d, which are adapted to implement various steps for ordering the service. A first business operation 102a in the example business process 112 defines instructions for collecting information about the service to be ordered. For example, a user may specify that a telephone line is to be ordered, and the user may specify a number of features to be included with the telephone line (e.g., caller identification, call waiting, long distance options, etc.). A second business operation 102b in the example business process 112 defines instructions for transmitting the service request to an enterprise management system for review. A third business operation 102c in the example business process 112 defines instructions for approving or denying the service request. For example, the third business operation 102c may evaluate a cost, an availability of the service, and/or other data and approve or deny the request. A fourth business operation 102d in the example business process 112 defines instructions for ordering the requested service. For example, the fourth business operation 102d may be executed conditionally upon receiving an approval from the third business operation 102c.

The illustrated example business process 112 also includes two data operations 104a and 104b to collect, analyze, and/or prioritize business data related to the business operations. A first data operation 104a defines instructions for extracting information of interest from business operation 102b. For example, the first data operation 104a may generate a data extractor to extract information of interest from the transmitted request such as, for example, a name or a department identification of the entity submitting the request, a cost of the requested service, and/or the features selected by the user. In some cases, the extracted business data can be used for statistical analysis. For example the business data can be used to identify the average cost of phone lines requested by the enterprise in each month or year. A second data operation 104b defines instructions for analyzing data related to the third business operation 102c and the fourth business operation 102d. For example, the second data operation 104b may provide business data for monitoring a cost of approved service requests and/or issuing an alert when an approved service request exceeds a certain amount, the second data operation 104b may calculate a tax value associated with approved service requests, and/or the second data operation 104b may monitor an amount of elapsed time between approval of a service request (at 102c) and transmittal of an order for the service (at 102d).

The business process 112 defined by the business process design tool 114 can be stored and/or executed locally, and/or the business process 112 can be transmitted over the network 130 to a different data processing system 120. For example, the business process 112 can be transmitted to a business process repository 120a for storage, and/or the business process 112 can be transmitted to the data processing system 120b for execution. The business process 112 may be defined and/or stored in a variety of different electronic file formats in a variety of different storage media. In some cases, the business process 112 is defined using a markup language code, such as extensible markup language (XML) or a different type of code. In some implementations, the business process 112 is stored in a single electronic file. In other implementations, the business process 112 is stored as multiple electronic files, for example, in multiple different file formats. For example, a first file may define the business operations 102 and a second file may define the data operations 104. In some implementations, a separate XML file defines the data operations 104.

The data processing system 120b includes an example business process execution engine 108. The business process execution engine 108 may be implemented as hardware, firmware, and/or software. For example, all or a portion of business process execution engine 108 may be implemented in commercially available software (e.g., SAP Netweaver, and/or others). In some cases, a business process execution engine implements enterprise resource procurement (ERP), supplier relationship management (SRM), customer relationship management (CRM), and/or other types of business processes. The business process execution engine 108 can initiate and execute a business process 112. Execution of a business process 112 can include execution of one or more of the business operations 102a, 102b, 102c, and/or 102d and execution of one or more of the data operations 104a and/or 104b. As the business process 112 is executed, the data operations 104 generate business data 106. For example, execution of the data operation 104a generates business data 106a, and execution of the data operation 104b generates business data 106b.

When the business process execution engine 108 executes the business process 112, the data operations 104 are automatically initiated to extract information of interest. In some cases, the business process execution engine 108 implements the business process 112 multiple times and business data 106 is collected over the multiple implementations. The extracted business data 106 can be used to analyze business activities, compute statistical information, and/or garner business intelligence related to individual business operations 102 in the business process 112, subsets of business operations 102 in the business process 112, and/or the business process 112 as a whole. The business data 106 can be stored locally by the data processing system 120b and/or transmitted over the network 130 to one or more additional data processing systems 120c, 120d, and/or 120e.

The data processing systems 120c, 120d, and 120e can include business warehouse systems, business intelligence systems, portal dashboards, alerting systems, and/or governance and compliance systems. For example, business warehouse systems can include information storage media and other hardware adapted to store business data 106. The business data 106 can be stored, for example as data structures, in a relational database, and/or in a variety of machine-readable media in various formats. Business intelligence systems can include processors and other hardware and/or software adapted to analyze business data 106. Business intelligence systems can be configured to generate statistical data and produce information that may be useful for analyzing business processes. Portal dashboards can provide monitoring capabilities, for example, to monitor values, status information, and/or other data associated with business processes. Alerting systems can generate and/or transmit alerts associated with business processes. For example, an alerting system can send an e-mail or any other type of message when a monitored value reaches or exceeds a certain threshold (e.g., as identified by a portal dashboard system). In some implementations, a portal dashboard receives business data 106 that includes a monitored value, the portal dashboard compares the monitored value to a pre-defined threshold, an alerting system sends an alert when the monitored value exceeds the threshold. Governance and compliance systems can perform checks to ensure that business processes and/or activities related to business processes conform to and/or comply with standards. In some cases, governance and compliance systems receive alerts from an alerting system. For example, when data indicates that an activity is out of compliance with enterprise and/or government standards, an alert may be generated by an alerting system and transmitted to a governance and compliance system.

A computing system for implementing a business process design tool 114 and/or a business process execution engine 108 may include a number of additional features not illustrated in the example system 100. Similarly, some of the features of the example system 100 may be implemented differently and/or omitted in some implementations. The features and capabilities described with respect to the data processing systems 110, 120a, 120b, 120c, 120d, and/or 120e may be integrated and/or distributed over any number of data processing systems. For example, the business process execution engine 108 and the business process design tool 114 may be integrated on a single data processing system or distributed over two, three, or more data processing systems. In some cases, the system 100 includes multiple business process design tools 114 and/or multiple business process execution engines 108.

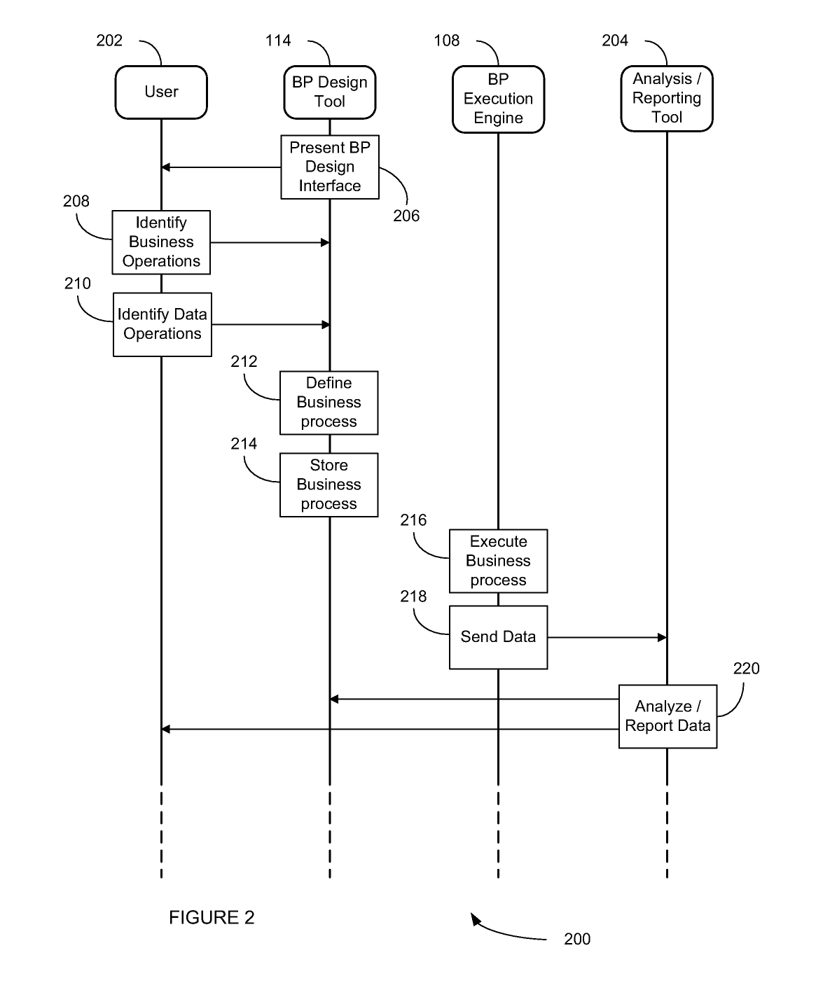

FIG. 2 is a signaling diagram illustrating an example process 200 for managing business information. The diagram illustrates communication among four entities of an enterprise. The illustrated entities are a user 202, a business process design tool 114, a business process execution engine 108, and an analysis and reporting tool 204. The user 202 can represent a human user (e.g., a business user) or a user interface device, such as a keyboard, a mouse, a microphone, or another type of user interface. The business process design tool 114 and the business process execution engine 108 represent the example business process design tool 114 and the example business process execution engine 108 of FIG. 1, respectively. The analysis and reporting tool 204 can represent a business warehouse system, a business intelligence system, a portal dashboard, an alerting system, and/or a governance and compliance system. For example, the analysis and reporting tool 204 can be implemented in one or more of the data processing systems 120c, 120d, and 120e of FIG. 1.

At 206, the business process design tool 114 presents a business process design interface to the user 202. For example, the business process design tool 114 may present a graphical user interface including drag-and-drop icons, pull-down menus, text-entry fields, sliders, radio buttons, charts, graphs, tables, formulae design tools, and/or other tools. The graphical user interface may be displayed on a monitor.

At 208, the user 202 identifies a business operation or multiple business operations to be included in a business process. For example, the business process design tool 114 may receive an identification of one or more business operations through a user interface device or a communication interface. At 210, the user 202 identifies a data operation or multiple data operations to be included in the business process. For example, the business process design tool 114 may receive an identification of one or more data operations through a user interface device or a communication interface. In some cases, the identification of business operations (208) and the identification of data operations (210) are implemented iteratively, concurrently, and/or in a different order.

At 212, the business process design tool 114 defines an automated business process that includes the business operations and the data operations. The business process may be adapted to initiate one or more of the data operations upon execution of one or more of the business operations. At 214, the business process design tool 114 stores the business process. The business process may be stored in a business process repository or any other data storage system in any format. The business process may be stored in a location that is readily accessible by a business process execution engine and/or other enterprise systems, so that the business process may be implemented multiple times by the enterprise.

At 216, the business process execution engine 108 executes the business process. When the business process is executed, the business operations and the data operations are implemented. The data operations are initiated based on execution of one or more of the business operations. For example, a particular business operation or subset of business operations may be associated with a particular data operation. When the particular business operation is carried out, the particular data operation may generate an information extractor to extract business data generated by the particular business operation or particular subset of business operations, or the particular data operation may perform some analysis, computation, or comparison of data based on the particular business operation or particular subset of business operations.

At 218, the business process execution engine 108 sends the business data to the analysis and reporting tool 204. At 220, the analysis and reporting tool 204 performs analysts of the business data and/or generates a report based on the business data. In some cases, the analysis and/or report may be transmitted to another entity in the enterprise. For example, the analysis and reporting tool 204 may send data to the business process design tool 114 and/or to the user 202. The user 202 and/or the business process design tool 114 may then use the data, for example, to modify the previously defined business process and/or to generate additional business processes. In some implementations, the business process execution engine 108 can alternatively or additionally send the business data to other logical, or physical locations (e.g., a database or business warehouse).

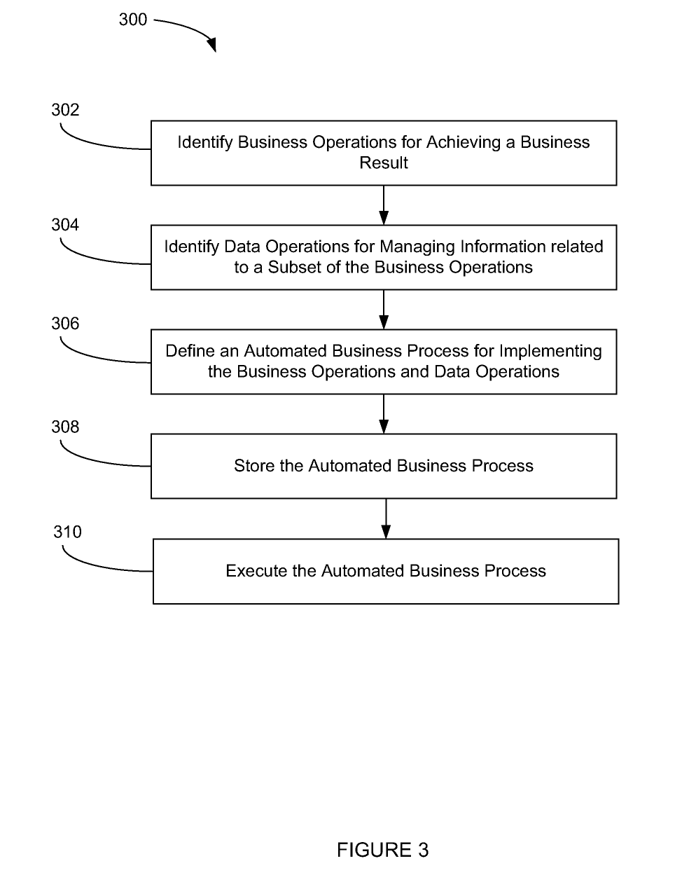

FIG. 3 is a flow diagram illustrating an example process 300 for managing business information. The example process 300 may be implemented by one or more data processing systems. The example process 300 allows a business process to be designed. The business process can be designed to include business operations for accomplishing a business goal or a business task and data operations for extracting data and/or performing business analysis. The data operations may be integrated into the business process, which may allow efficient extraction and/or prioritization of information of interest and may reduce or eliminate a need to search, sort, and/or filter data generated during business process implementation. Implementations of the process 300 may include all, some, and/or additional operations implemented in the same or a different order.

At 302, one or more business operations are identified, for example, for achieving a business objective or business task of an enterprise or an entity of an enterprise. For example, the business objective or business task may include ordering a business asset, ordering a business service, managing employees of the enterprise, managing assets of the enterprise, communicating with customers of the enterprise, or marketing a good or a service of the enterprise. The business operations can be defined by receiving data from a user through a user interface. For example, a business process design tool may allow a user to design a business process using a graphical user interface. In some cases, a user may select a previously-defined business operation (e.g., from a list or a menu), a user may parameterize or otherwise adapt a generic template business operation for a specific purpose, a user may manually type a script, a program, or another type of computer code that defines a business operation, business operations may be uploaded from a previously-defined business process, and/or business operations may be automatically selected or identified based on other data.

At 304, data operations are identified for managing information related to a subset of the business operations. The data operation can be identified by the user through a user interface. The data operation can be identified concurrently with or approximately concurrently with identifying the business operations (302). The data operation can define an operation for managing information related to analysis of an efficiency and/or an effectiveness of the subset of business operations. The data operation can define an operation for automatically storing data related to the subset of business operations. The data operation can define an operation for automatically prioritizing, sorting, filtering, and/or identifying an importance of business data. The data operation can identity a most important data field or multiple high priority data fields associated with the subset of business operations. Examples data fields include a name, a current date, an address, an age, a birthday, a phone number, an e-mail address, a web address, a domain name, an IP address, a location, an article or book citation, a page number, a product name, a product version, a manufacturer name, a customer identification, a vendor identification, a purchase order number, a sales order number, a total cost, a net cost, a tax value, a volume, a weight, a size dimension, an amount of time, a time of day, or any other data field that may be of interest for analyzing a business process. The data operation can define an operation for automatically providing data to at least one of a business intelligence system or a business warehouse system upon implementation of the subset of business operations. The subset of business operations may include only one business operation, or the subset of business operations may include multiple business operations (e.g., two or more business operations).

At 306, an automated business process for implementing the business operations and data operations is defined. In some cases, the automated business process is adapted to initiate the data operation concurrently with implementation of at least a portion of the subset of business operations. The business process may be stored in a format suitable for implementation by a business process execution engine. The business process may be stored for repeated use by the enterprise.

At 308, the automated business process is stored, for example, to be used by an enterprise to accomplish the business result or the business task. The automated business process may be stored and/or communicated partially or wholly as an XML document and/or in another format.

At 310, the automated process is executed. Executing the business process can include executing one or more of the business operations, which may include executing the subset of business operations. Executing the business process may include executing a compiled code and/or an interpreted code. Executing the business process may include converting a code to assembly language and/or machine language. The business process may be executed interpretively. The data operation is initiated based on execution of the subset of business operations. The data operation may extract or calculate business data based on the execution of the business operations. Execution of the subset of business operations may instantiate a data value for a data field related to the subset of business operations. The data operation may define an operation for comparing the instantiated data value to a threshold data value. The data operation may define an equation for analysis of the data values. The data operation may define a relationship among at least two of the data fields. The data operation may define an operation for comparing the data values to a data condition. The data operation may define an operation for generating an alert and/or for communicating with governance and compliance systems.

In some cases, the process 300 includes further operations. For example, multiple additional data operations may be defined for managing information related to multiple additional subsets of the business operations. The automated business process initiates each additional data operation based on execution of a corresponding subset of the business operations. A business warehouse may store the business data, and a business intelligence system may analyze the business data. The business process may be modified and/or redesigned based on the business data and/or based on analysis of the business data.

The invention and all of the functional operations described in this specification can be implemented in digital electronic circuitry, or in computer software, firmware, or hardware, including the structural means disclosed in this specification and structural equivalents thereof, or in combinations of them. The invention can be implemented as one or more computer program products, i.e., one or more computer programs tangibly embodied in an information carrier, e.g., in a machine readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the invention, can be performed by one or more programmable processors executing one or more computer programs to perform functions of the invention by operating on input data and generating output. The processes and logic flows can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, the processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The invention can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

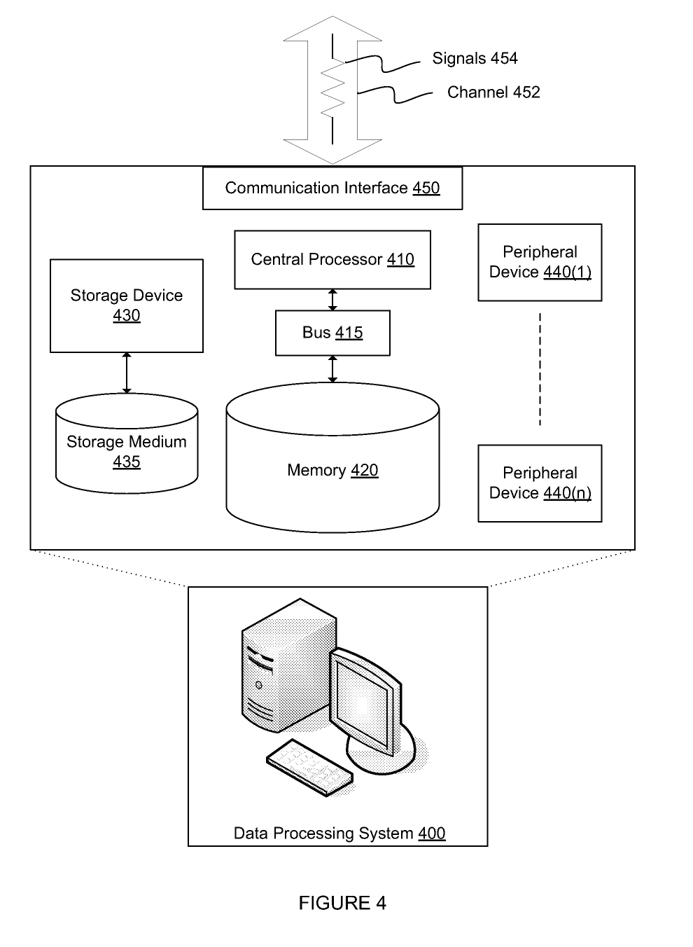

FIG. 4 is a block diagram illustrating an example data processing system 400 in which a business process design tool, a business process execution engine, an analysis and reporting tool, and/or other aspects of the present disclosure can be implemented. The data processing system 400 includes a central processor 410, which executes programs, performs data manipulations, and controls tasks in the system 400. The central processor 410 is coupled with a bus 415 that can include multiple busses, which may be parallel and/or serial busses.

The data processing system 400 includes a memory 420, which can be volatile and/or non-volatile memory, and is coupled with the communications bus 415. The system 400 can also include one or more cache memories. The data processing system 400 can include a storage device 430 for accessing a storage medium 435, which may be removable, read-only, or read/write media and may be magnetic-based, optical-based, semiconductor-based media, or a combination of these. The data processing system 400 can also include one or more peripheral devices 440(1)-440(n) (collectively, devices 440), and one or more controllers and/or adapters for providing interface functions.

The system 400 can further include a communication interface 450, which allows software and data to be transferred, in the form of signals 454 over a channel 452, between the system 400 and external devices, networks, or information sources. The signals 454 can embody instructions for causing the system 400 to perform operations. The system 400 represents a programmable machine, and can include various devices such as embedded controllers, Programmable Logic Devices (PLDs), Application Specific Integrated Circuits (ASICs), and the like. Machine instructions (also known as programs, software, software applications or code) can be stored in the machine 400 and/or delivered to the machine 400 over a communication interface. These instructions, when executed, enable the machine 400 to perform the features and functions described above. These instructions represent controllers of the machine 400 and can be implemented in a high-level procedural and/or object-oriented programming language, and/or in assembly/machine language. Such languages can be compiled and/or interpreted languages.

A number of implementations have been described. Nevertheless, it will be understood that various modifications may be made. Accordingly, other implementations are within the scope of the following claims.

What is claimed is:

1. A method for managing business information in an enterprise, the method comprising:
defining a plurality of business operations for achieving a business objective in an enterprise;
identifying a data operation for managing information related to a subset of the plurality business operations;
defining an automated business process for implementing the plurality of business operations and the data operation, wherein the automated business process initiates the data operation based on execution of the subset of business operations; and
storing the automated business process for repeated use in the enterprise.

2. The method of claim 1, wherein the business objective comprises at least one of ordering a business asset, ordering a business service, managing employees of the enterprise, managing assets of the enterprise, communicating with customers of the enterprise, or marketing a good or a service of the enterprise.

3. The method of claim 1, wherein the data operation defines an operation for managing information related to analysis of at least one of an efficiency or an effectiveness of the subset of business operations.

4. The method of claim 1, wherein the data operation defines an operation for automatically storing data related to the subset of business operations.

5. The method of claim 1, wherein execution of the subset of business operations instantiates a data value for a data field related to the subset of business operations, and the data operation defines an operation for comparing the instantiated data value to a threshold data value.

6. The method of claim 1, wherein execution of the subset of business operations instantiates data values for a plurality of data fields related to the subset of business operations, and the data operation defines an equation for analysis of the data values.

7. The method of claim 1, wherein execution of the subset of business operations instantiates data values for a plurality of data fields related to the subset of business operations, and the data operation defines a relationship among at least two of the data fields.

8. The method of claim 1, wherein execution of the subset of business operations instantiates data values for a plurality of data fields related to the subset of business operations, and the data operation defines an operation for comparing the data values to a data condition.

9. The method of claim 1, wherein the data operation defines an operation for automatically providing data to at least one of a business intelligence system or a business warehouse system upon implementation of the subset of business operations.

10. The method of claim 1, wherein the automated business process initiates the data operation concurrently with implementation of at least a portion of the subset of business operations.

11. The method of claim 1, wherein the subset of business operations comprises no more than one business operation.

12. The method of claim 1, wherein the subset of business operations comprises more than one business operation.

13. The method of claim 1, further comprising identifying a plurality of additional data operations for managing information related to a plurality of additional subsets of the business operations, wherein the automated business process initiates each additional data operation based on execution of a corresponding subset of the business operations.

14. The method of claim 1, wherein:
the plurality of business operations are defined by receiving data from a user through a user interface; and
the data operation is identified by the user through a user interface.

15. The method of claim 14, wherein the data operation is identified approximately concurrently with defining the plurality of business operations.

16. A computer program product, tangibly stored on a computer-readable medium, comprising instructions operable to cause a programmable processor to:
receive an identification of a plurality of business operations for achieving a business objective in an enterprise;
receive an identification of a data operation for managing information related to a subset of the plurality business operations; and
generate an electronic document for use in implementing the plurality of business operations and the data operation, wherein the electronic document is adapted to initiate the data operation based on execution of the subset of business operations.

17. The computer program product of claim 16, further comprising instructions operable to cause a programmable processor to:
execute the subset of business operations using a business process execution engine; and
initiate the data operation using the business process execution engine, wherein the data operation is initiated based on the execution of the subset of business operations.

18. The computer program product of claim 17, further comprising instructions operable to cause a programmable processor to generate a data extractor using the business process execution engine, wherein the data extractor is generated based on the initiation of the data operation.

19. The computer program product of claim 16, further comprising instructions operable to cause a programmable processor to generate a graphical user interface allowing a user to provide identification of at least one of the subset of business operations or the data operation.

20. The computer program product of claim 16, further comprising instructions operable to cause a programmable processor to generate a graphical user interface allowing a user to provide identification of a report to generate upon execution of the subset of business operations.

21. The computer program product of claim 16, wherein the electronic document comprises an extensible markup language (XML) document.

22. A system for managing business information in an enterprise, the system comprising:
at least one interface operable to receive:
an identification of a plurality of business operations for achieving a business objective in an enterprise, wherein an execution of each business operation impacts at least one data field; and
an identification of a data operation for managing information related to the at least one data field;
a memory operable to store machine-readable data defining an automated business process for implementing the plurality of business operations and the data operation, wherein the automated business process initiates the data operation based on implementation of the subset of business operations.

23. The system of claim 22, wherein the interface comprises at least one of a user interface or a communication interface.

24. The system of claim 22, wherein the memory comprises at least one of a removable storage medium, a read only memory (ROM), or a random access memory (RAM).

25. The system of claim 22, wherein the identification of a data operation defines a relative importance of at least one data field relative to the other data fields.
